(19) United States
(12) Patent Application Publication
(10) Pub. No.: US 2015/0002431 A1
(43) Pub. Date: Jan. 1, 2015

(54) METHOD AND APPARATUS FOR OPERATING LOCK SCREEN OF ELECTRONIC DEVICE

(71) Applicant: Samsung Electronics Co., Ltd., Gyeonggi-do (KR)

(72) Inventors: Hyemi LEE, Incheon (KR); Sanghyuk KOH, Jeju-do (KR); Taeyeon KIM, Seoul (KR); HeeJin KIM, Seoul (KR); Bohyun SIM, Incheon (KR); Sihak JANG, Gyeonggi-do (KR)

(73) Assignee: Samsung Electronics Co., Ltd.

(21) Appl. No.: 14/321,257

(22) Filed: Jul. 1, 2014

(30) Foreign Application Priority Data
Jul. 1, 2013 (KR) 10-2013-0076466

(51) Int. Cl. G06F 3/041

(52) U.S. Cl. CPC G06F 3/0416; G06F 3/0412
USPC 345/173

(57) ABSTRACT

A method and an apparatus for operating a lock function in an electronic device are provided. The method includes displaying an image on a lock screen when the lock screen is called; detecting a user input in a state in which the image is displayed; and releasing the lock screen when the user input is identical with a lock release value, wherein at least one of a point, a line, and a plane forming an image corresponding to the image is included in a drawing value for releasing the lock screen.

### PRIORITY

This application claims priority under 35 U.S.C. §119(a) to a Korean Patent Application filed on Jul. 1, 2013 in the Korean Intellectual Property Office and assigned Serial No. 10-2013-0076466, the entire content of which is incorporated herein by reference.

### BACKGROUND

1. Field of the Invention

The present invention generally relates to an electronic device, and more particularly, to a method of operating a lock screen of an electronic device for operating a personalized lock screen and an apparatus thereof.

2. Description of the Related Art

In recent years, electronic devices have been manufactured to further meet the convenience of a user by taking a User Interface (UI) or a User Experience (UX) design into consideration in addition to the overall performance of the device (e.g., throughput, response time, availability, and the like).

### SUMMARY

The present invention has been made in view of the above problems and disadvantages, and to provide at least the advantages described below. Accordingly, an aspect of the present invention provides a method for operating a lock screen of a portable terminal capable of providing a lock function within a proper range while satisfying various needs of a user when operating the lock screen of the portable terminal, and an apparatus thereof.

In accordance with an aspect of the present invention, a method for operating a lock function in an electronic device includes displaying an image on a lock screen when the lock screen is called; detecting a user input in a state in which the image is displayed; and releasing the lock screen when the user input is identical with a lock release value, wherein at least one of a point, a line, and a plane forming an image corresponding to the image is included in a drawing value for releasing the lock screen.

In accordance with another aspect of the present invention, a method for operating a lock function includes displaying an image selected from one or more images; receiving a user input including at least one of a point, a line, and a plane forming the displayed image; and storing the user input as a lock release value of the image.

In accordance with another aspect of the present invention, an electronic device for operating a lock function includes a display unit to display an image on a lock screen when the lock screen is called; a touch panel to detect a user input in a state in which the image is displayed; and a controller to release the lock screen when the user input is identical with a lock release value, wherein at least one of a point, a line, and a plane forming an image corresponding to the image is included in a drawing value for releasing the lock screen.

In accordance with another aspect of the present invention, an electronic device includes a display unit to display an image selected from one or more images; a touch panel to receive a user input including at least one of a point, a line, and a plane forming the displayed image; a controller to control to store the user input as a lock release value of the image; and a storage unit to store the lock release value and the selected image.

### BRIEF DESCRIPTION OF THE DRAWINGS

The above aspects, features and advantages of the present invention will be more apparent from the following detailed description, taken in conjunction with the accompanying drawings, in which:

FIG. 1 is a block diagram illustrating a schematic configuration of an electronic device according to an embodiment of the present invention;

FIG. 2 is a flowchart illustrating a method of executing a release function of a lock screen on an electronic device according to an embodiment of the present invention;

FIGS. 3A to 3C are screen views for illustrating a procedure of executing a release function of a lock screen on an electronic device according to an embodiment of the present invention;

FIG. 4 is a flowchart illustrating a procedure of setting a lock screen of an electronic device according to an embodiment of the present invention;

FIGS. 5A and 5B are screen views for illustrating an operation of the lock screen of an electronic device according to an embodiment of the present invention;

FIGS. 6A to 6C are screen views for illustrating a procedure of setting a lock screen according to an embodiment of the present invention;

FIGS. 7A and 7B are screen views illustrating setting a degree of difficulty for a lock setting according to an embodiment of the present invention; and

FIGS. 8A to 8D are screen views for illustrating other examples of execution of a release function of the lock screen according to an embodiment of the present d invention.

### DETAILED DESCRIPTION OF EMBODIMENTS OF THE PRESENT INVENTION

Embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

The present invention displays a lock image on a lock screen of an electronic device, and releases the lock screen by drawing on the lock image.

The lock image serves as a lock screen through the image itself. In detail, the present invention uses at least one of a point, a line, and a plane forming the lock image as an element included in a lock release pattern. Accordingly, the present invention provides the lock image as the lock screen, and does not require an input window for inputting a separate lock pattern or a lock pass word. When the lock image is provided as the lock screen, a user performs a specific gesture, e.g., a drawing input, on the lock image. When the drawing input is the same as a previously defined lock release pattern, the electronic device releases a lock function to output a screen according to preset schedule information on a display unit. In this case, an image used as the lock image may include at least one of a point, a line, and a plane which form an image. At least one of the point, the line, and the plane may be included in a drawing value for the lock release. For example, when items such as eyeglasses or a ribbon are included in the lock image, and the user previously sets, for example, the rim of the eyeglasses an edge of the ribbon, and the like, as a lock release pattern, the rim of the eyeglasses or the edge of the ribbon may be a lock release value.

A portable device equipped with a lock function according to the present invention may include a smart phone, a tablet Personal Computer (PC), a Personal Digital Assistant (PDA), and the like.

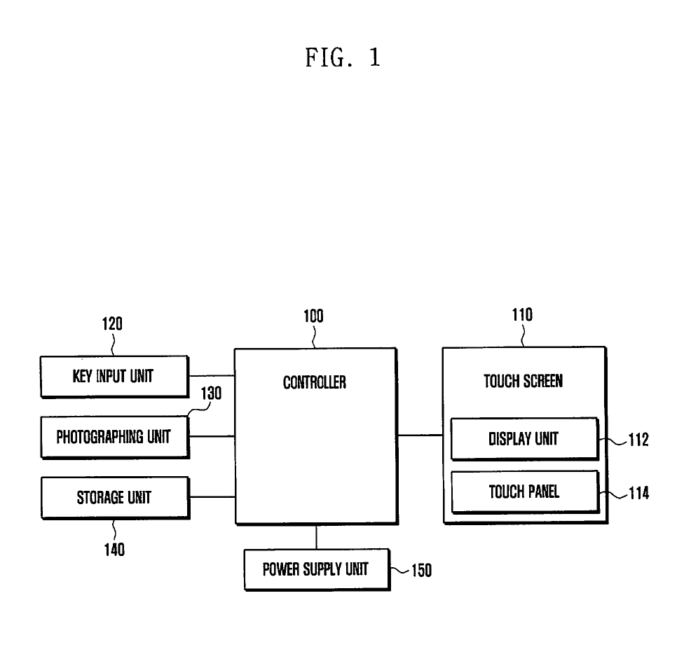

FIG. 1 is a block diagram illustrating a schematic configuration of an electronic device according to an embodiment of the present invention.

Referring to FIG. 1, the electronic device according to an embodiment of the present invention includes a touch screen 110, a display unit 112, a touch panel 114, a key input unit 120, a photographing unit 130, a storage unit 140, a power supply unit 150, and a controller 100.

The touch screen 110 includes the display unit 112 and the touch panel 114.

The display unit 112 displays various images according to utilization of the electronic device under control of the controller 100. For example, the various images may include a lock screen, a home screen, an App list screen, an App execution screen, a character input screen, and the like. If the controller 100 processes (e.g., decodes) information to store the processed information in a memory (e.g., a frame buffer), the display unit 112 displays the data stored in the frame buffer. The display unit 112 may include a Liquid Crystal Display (LCD), an Active Matrix Organic Light Emitted Diode (AMOLED), a Flexible display, or a transparent display. The display unit 112 displays the lock image under control of the controller 100. Further, the display unit 112 may display various screens to set a lock screen under the control of the controller 100. The various screens displayed on the display unit 112 will be described below in detail.

The touch panel 114 may be a capacitive overlay type, a resistive overlay type, or an infrared beam type. The touch panel 114 generates a touch event in response to a gesture of a user for a screen, and analog to digital (AD)-converts the generated touch event to transfer the digital touch event to the controller 100. In this case, the touch event includes at least one touch coordinate (x, y). For example, an integrated circuit (IC) of the touch panel 114 detects a touch of the user, and determines a touch region in response to the touch. The touch IC transfers the touch coordinate (x, y) included in the touch region to the controller 100. In particular, while the lock image is displayed on the display unit 112, the touch panel 114 transfers the touch coordinate (x, y) according to a user input, e.g., a drawing input to the controller 100.

Further, the touch panel 114 determines an input device through a touch sensor under the control of the controller 100. The input device may include a touch pen or a finger. The touch panel 114 may be provided in various forms according to a characteristic of the input device. For example, in the electronic device applying the touch pen, when the touch pen is an electromagnetic induction pen, the touch panel 114 includes an electromagnetic induction panel. The touch panel 114 may include a capacitive overlay touch panel to recognize a capacitive overlay touch pen or a finger. The touch panel 114 may include at least one of the above mentioned various panels. The present invention presents a configuration of the touch panel 114 to collect a drawing input of a user in a state in which the lock image is output on the display unit 112. Accordingly, the present invention is not limited to the type or the number of the touch panel 114, but various types of panels for the drawing input may be used as the touch panel 114.

The key input unit 120 generates a user input to control the portable terminal. When the portable terminal supports a full touch screen, the key input unit 120 may include a power key, a side key, a home button, and the like. In particular, the key input unit 120 transfers the user input for a call of the lock screen to the controller 100. To this end, the key input unit 120 may include a specific key, e.g., a power key or a home key to call the lock screen.

The photographing unit 130 photographs a still image and a moving image of a subject under control of the controller 100, and transfers the photographed image data to the display unit 112 and the controller 100. The present invention can use an image received from another electronic device, an external server device, and the like, as well as a pre-stored image, as the lock image when providing a lock image. Further, the present invention can use a collected specific image as the lock image when the photographing unit 130 collects the specific image. Accordingly, when the electronic device of the present invention is limited to use only the stored image in order to operate the lock image, the photographing unit 130 may be omitted from the configuration of the electronic device.

The storage unit 140 stores a booting program, an Operating System (OS), and applications, and in particular, the storage unit 140 stores various images. In this case, the various images may include an image transmitted from another portable terminal, an image collected from the photographing unit 130, an image stored in a gallery, and a background screen image of the electronic device. Further, the images may be divided into a lock image and an unlocked image. In addition, the storage unit 140 stores a drawing value set for lock release under control of the controller 100. In this case, a lock release value may be mapped to a specific lock image to be stored. In the present invention, the lock release value may be changed according to the lock image. That is, when the image is changed, an image constituent element including at least one of a point, a line, and a plane included in each image may be changed. Accordingly, the lock release values may be differently set according to the image. For example, in a case of an image of a user's face wearing eyeglasses, an edge line of the eyeglasses may be a lock release value according to user setting. Further, in a case of an image of a flowerpot with flowers, an edge line of the flowerpot may be the lock release values. Meanwhile, the same image may have different lock release value. In the above example, in the case of the image of the flowerpot with flowers, an edge line of the flower may be a lock release value according to a user setting or setting change. The storage unit 140 maps a lock release value set by the user to a corresponding lock image to store the mapping result with respective lock images.

The power supply unit 150 receives power from an external power source or an internal power source and supplies power necessary for operation of respective constituent elements.

The controller 100 controls an overall operation of the portable terminal and a signal flow between internal configurations of the portable terminal, and performs a processing data function. Further, the controller 170 controls power supply from a battery to the internal configurations of the portable terminal. In particular, the controller 100 controls the display unit 112 to display a lock image to which a lock function is set according to call of the lock screen. Further, the controller 100 collects a touch event, e.g., a drawing input generated from the touch panel 114, and determines whether the drawing input detected through the touch panel 114 is identical to the lock release value stored in the storage unit 140. When the value of the drawing input is identical to the stored lock release value, the controller 100 releases the lock screen.

Meanwhile, the controller 100 sets the lock screen. To this end, the controller 100 controls the display unit 112 to output at least one stored image. Further, the controller 100 sets a specific touch event, e.g., the drawing input collected from the touch panel 114, as a lock release value for a corresponding image. In addition, the controller 100 may change a lock release value of the lock image. To this end, the controller 100 controls the display unit 112 to output a lock image according to selection of the user in a lock screen setting mode. Then, the user performs a drawing input to change the lock release value. The controller 100 collects touch event values from the touch panel 114 to set the collected touch event values as a new lock release value of the lock image. In this case, an input lock release value may be a specific type of drawing value including at least one of a point, a line, and a plane forming a corresponding image, and the lock release value includes a location value for at least one point included in the image, a track value of at least one line, and an edge value of at least one plane. The lock release value may have a certain order value according to a setting of a degree of difficulty for locking the screen. For example, even if a plurality of points are set as the lock release value, an order value of the respective points may be set according to the setting of the degree of difficulty for locking the screen. If a low degree of difficulty for locking the screen is set, a specific drawing value including all of the points regardless of the order may be the lock release value.

Such a function may be similarly applicable to a line as well as a plurality of points. For example, assuming that there is the eyeglasses image and a rim of the eyeglasses is the lock release value, if the order value of a start point and a track for drawing the rim of the eyeglasses is identical to a preset value based on the degree of difficulty for locking the screen, the lock screen is released. Alternatively, when the relatively low degree of difficulty for locking the screen is set, a drawing value drawing a line connecting a rim of the eyeglasses may be the lock release value regardless of an order of the start point or the track for drawing the rim of the eyeglasses. The controller 100 may provide a menu to set the degree of difficulty on a screen in which the setting of the lock for a specific image is performed in order to set the degree of difficulty for locking the screen. For example, as a menu item, the degree of difficulty for locking the screen may be provided with a high level, a middle level, and a low level. In a case of the high level, the lock release value may include a start point, a track, and an end point in a specific location in the lock image. In a case of the middle level, the lock release value may include the start point and track information. In a case of the low level, the lock release value may include only the start point and the end point. The setting of the level and the setting of accuracy of a corresponding lock release value may be changed according to a setting type of the user and various design schemes.

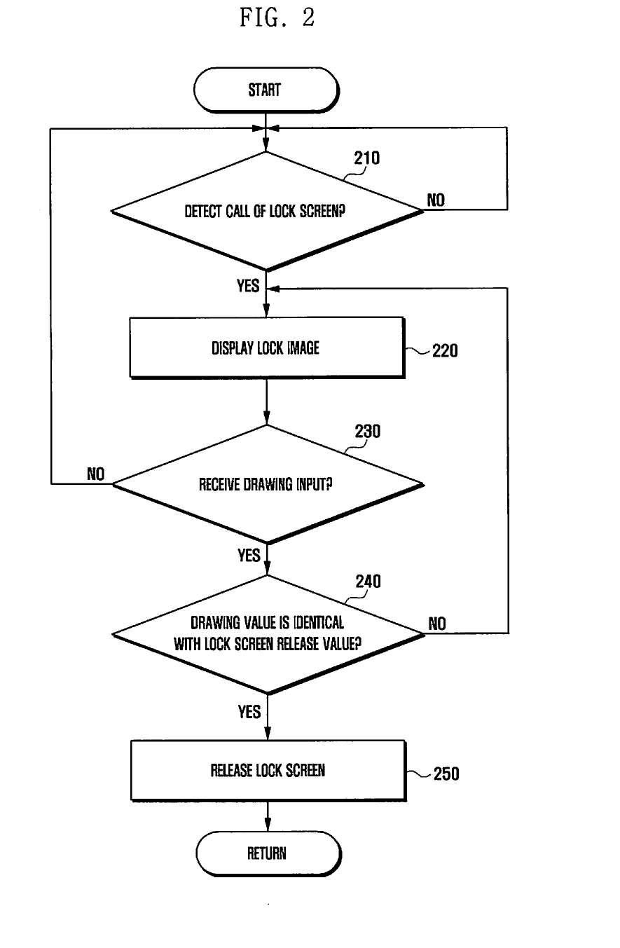

FIG. 2 is a flowchart illustrating a method of executing a release function of a lock screen on an electronic device according to an embodiment of the present invention.

Referring to FIG. 2, with the controller 100 in a standby mode to detect a user input in an idle state of the electronic device, at step 210, the controller 100 detects an input for a call of a lock screen through the key input unit 120. The key input unit 120 may include a power key or a home button to detect a user input.

If the input for the call of the lock screen is detected, at step 220, the controller 100 displays a previously defined lock image on the display unit 112. If the lock image is displayed on the display unit 112, the controller 100 may be in the standby mode to detect the user input. In this case, if a drawing input is detected at step 230, the controller 100 receives a drawing input value from the touch panel 114. That is, the controller 100 detects a touch coordinate (x, y) for the drawing through the touch panel 114. If a drawing input is not detected at step 230, the controller 100 returns to step 210 to detect an input for a call of a lock screen.

If the drawing input is detected at step 230 through the touch panel 114, at step 240, the controller 100 determines whether a drawing value is identical with a lock screen release value stored in the storage unit 140. In this case, when the drawing value is identical with the lock screen release value, at step 250, the controller 100 releases the lock screen. Further, the controller 100 may execute a home screen or a corresponding function according to a setting stored in the storage unit 140. If the drawing value is not indicated with a lock screen release value in step 240, the controller 100 returns to step 220 to display the previously defined lock image.

As described above, the electronic device of the present invention may output only the lock image on the display unit 112 without an output of a window for a separate lock release pattern or a lock pass word input. The lock image may serve as a lock function simultaneously with serving as a background screen of a lock screen. Accordingly, the user may use favorite photos, or the like, as a lock screen in a state in which at least a part of the photo, or the like, is not covered with another lock pattern. Further, since a region for a separate lock pattern input is not provided, only the user who set the lock release value may perform lock release for a corresponding lock image. As a result, the present invention may provide a more familiar lock function to the user while providing a more improved security.

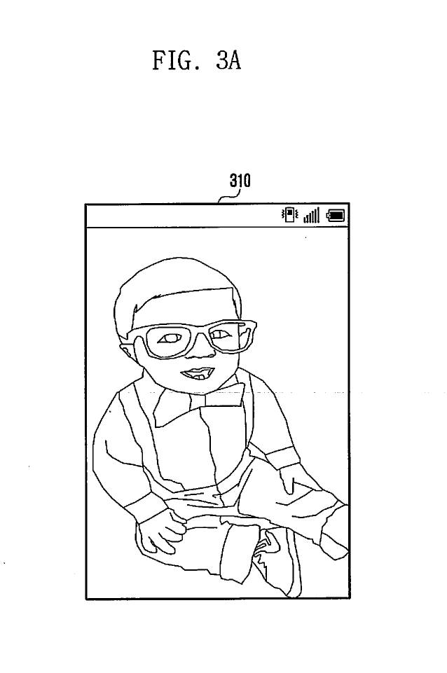

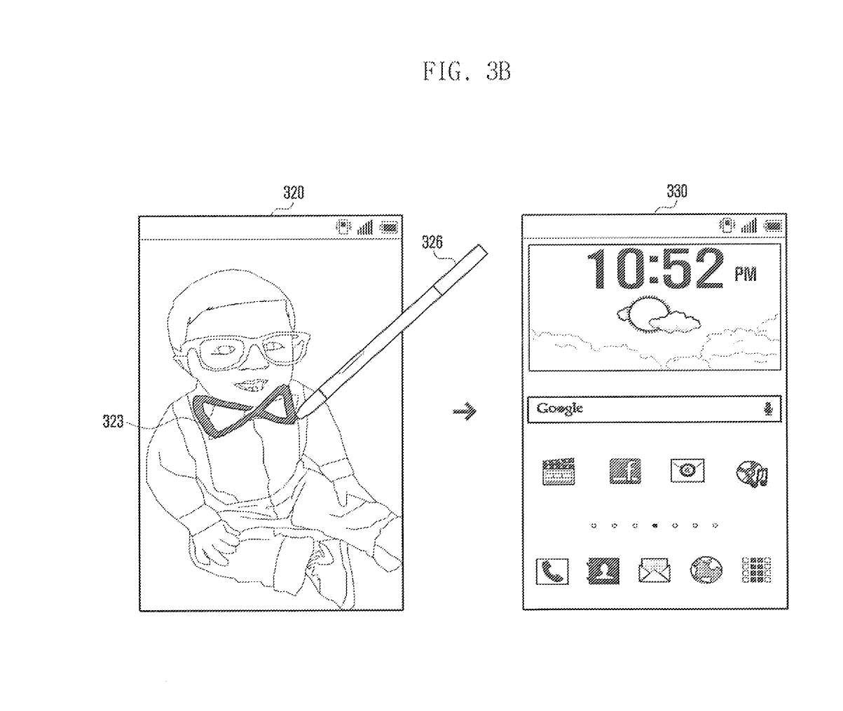

FIGS. 3A to 3C are screen views for illustrating a procedure of executing a release function of a lock screen on an electronic device according to an embodiment of the present invention.

Referring to FIGS. 3A to 3C, if a call for the lock screen is detected, the controller 100 displays a previously defined lock image on the display unit 112 as illustrated on a screen 310 in FIG. 3A. In this case, the lock image is an image to which a lock function is set. If the lock image is output on the display unit 112, the user may perform a specific input gesture, e.g., a touch pen drawing 323 using a touch pen 326 on the lock image. Then, the controller 100 detects the touch pen drawing 323 for release of the lock screen through the touch panel 114. During a procedure of inputting the touch pen drawing 323, the user inputs the touch pen drawing 323 using the touch pen 326 as illustrated on a screen 320 in FIG. 3B. The controller 100 detects the touch pen drawing 323 for the touch pen 326 through a touch sensor.

If an input of the touch pen drawing 323 is collected, the controller 100 compares the input of the touch pen drawing 323 with a lock release value stored in the storage unit 140. When the input of the touch pen drawing 323 is identical with the lock release value, the controller 100 releases the lock screen. The controller 100 controls the display unit 112 to display a specific screen, e.g., a home screen as illustrated on a screen 330 in FIG. 3B.

Meanwhile, an input gesture for inputting the lock release value may be a finger drawing 343 using a finger 346 as illustrated on a screen 340 in FIG. 3C. If the finger drawing 343 is input, the controller 100 compares the input of the finger drawing 343 with the lock release value. If the input of the finger drawing 343 is identical with the lock release value, the controller 100 controls the display unit 112 to display a home screen as illustrated on a screen 350 in FIG. 3C.

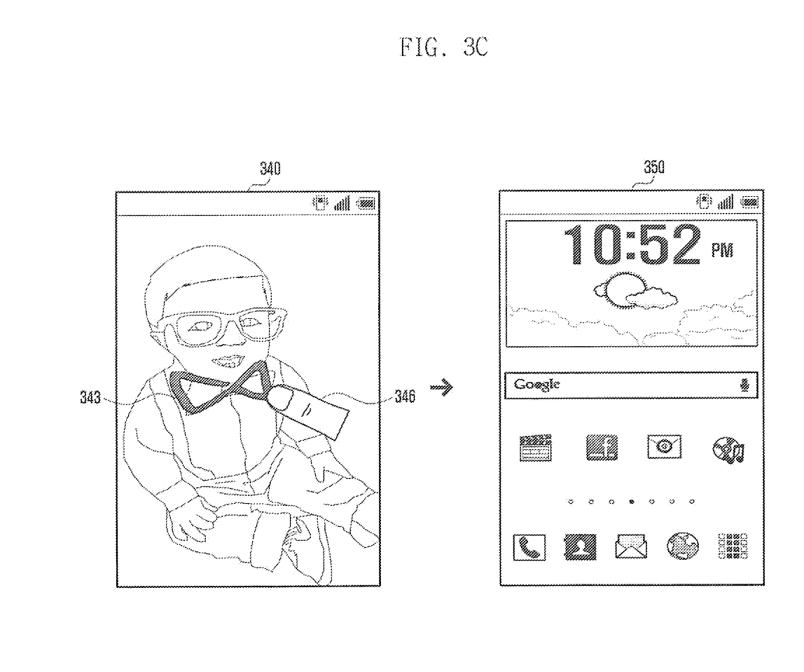

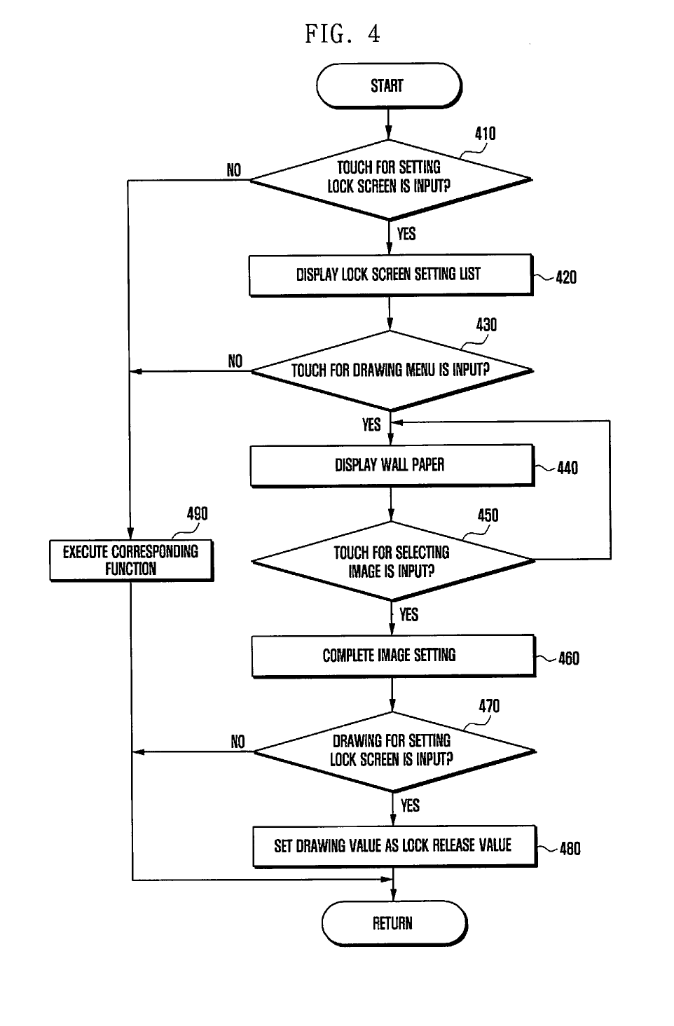

FIG. 4 is a flowchart illustrating a method of setting a lock screen of an electronic device according to an embodiment of the present invention.

Referring to FIG. 4, at step 410, the controller 100 determines whether a touch for setting of lock screen is input. In this case, when the touch for setting the lock screen is input, at step 420, the controller 100 controls the display unit 112 to display a lock screen setting list. Meanwhile, when a specific hot key is allocated to the key input unit 120 in order to set the lock screen, the controller 100 controls to activate a lock screen setting function at a time of inputting a corresponding hot key. The lock screen setting list may include various lists for the lock function. For example, the lock screen setting list may include a drawing menu.

Accordingly, at step 430, the controller 100 determines whether a touch for the selection of a drawing menu is input. Further, if the touch for selection of the drawing menu is input, at step 440, the controller 100 controls the display unit 112 to display at least one image, e.g., at least one wall paper. In this case, the wall paper may be one of images which may be used as the lock image of the present invention.

If the wall paper is displayed on the display unit 112, at step 450, the controller 100 determines whether a touch for selecting an image is input. That is, the controller 100 determines whether any one of a plurality of wall papers is selected to form a lock image.

At step 450, the controller 100 completes the image setting when the image is selected according to the touch for selecting the image.

When the touch for selecting the image is not input at step 450, the controller 100 returns to step 440 to maintain the wall paper. Alternatively, the controller 100 may execute a preset specific schedule function, e.g., a sleep function. Further, a wall paper display function may be cancelled according to input control of the user. Accordingly, the electronic device may output the home screen or may perform a function change to a preset specific function.

At step 450, the controller 100 may detect an input of a direct photographing when selecting the image. To this end, the controller 100 may provide a photographing mode menu to set the lock image. If the photographing mode menu is selected, the controller 100 activates the photographing unit 130 to support a photographing function. In addition, if a specific image is photographed, the controller 100 may use a corresponding image as the lock image.

The controller 100 may also detect an input of a gallery when selecting the image. To this end, the controller 100 may provide a gallery photograph selection menu to set the lock image. If a corresponding menu is selected, the controller 100 controls the display unit 112 to output a gallery screen including at least one image.

The controller 100 may set a new lock release value for the lock image when selecting the image. If the new lock release value for the lock image is set, the controller 100 controls to remove an existing lock release value of a corresponding lock image.

If a specific image is selected for forming the lock image, at step 470, the controller 100 determines whether a drawing for setting the lock screen is input. If the drawing for setting the lock screen is input from the touch panel 114, at step 480, the controller 100 sets a corresponding drawing value as a lock release value of a corresponding image. To this end, the controller 100 may map the corresponding drawing value to a corresponding image to store the mapping result in the storage unit 140.

In this case, the controller 100 identifies an input device for the drawing. The input device may include a touch pen or a finger. That is, the controller 100 may map an input signal generation tool of a lock release value of a specific lock image to the lock release value to store the mapping result. Accordingly, although a drawing value input after the lock image is output on the display unit 112 is identical with the lock release value, the controller 100 may determine validity of a corresponding drawing value according to whether a drawing input type is a finger or a touch pen.

The controller 100 may request that the user provide a repetitive drawing input in order to support accuracy of setting for a lock release value or to support an error tolerance during a drawing setting procedure. Then, the user may repeatedly input a drawing value to be used as the lock release value in a state in which a specific image is output. During this procedure, the controller 100 calculates the error tolerance or accuracy of the drawing value by using a repeated input drawing value. The error tolerance may be calculated to include all parts with which drawing values are not identical. Alternatively, the controller 100 may set a specific drawing value as a standard lock release value by selecting an average value for the parts having different drawing values. Further, the controller 100 may apply an error tolerance defined with a default or defined according to user designation to a standard lock release value. In this case, if a touch input for drawing is transferred from the touch panel 114, the controller 100 controls to apply an image effect corresponding to the relevant touch input to the lock image to display the lock image to which the image effect is applied. The output of the image effect enables a user to clearly identify the lock release value set by the user. The controller 100 stores and sets the drawing value collected according to the touch input as the lock release value.

When the touch for setting a lock screen is not input at step 410, the touch for selection a drawing menu is not input at step 430, or the drawing for setting the lock screen is not input at step 470, the controller 100 controls to execute a specific function according to the user input at step 490.

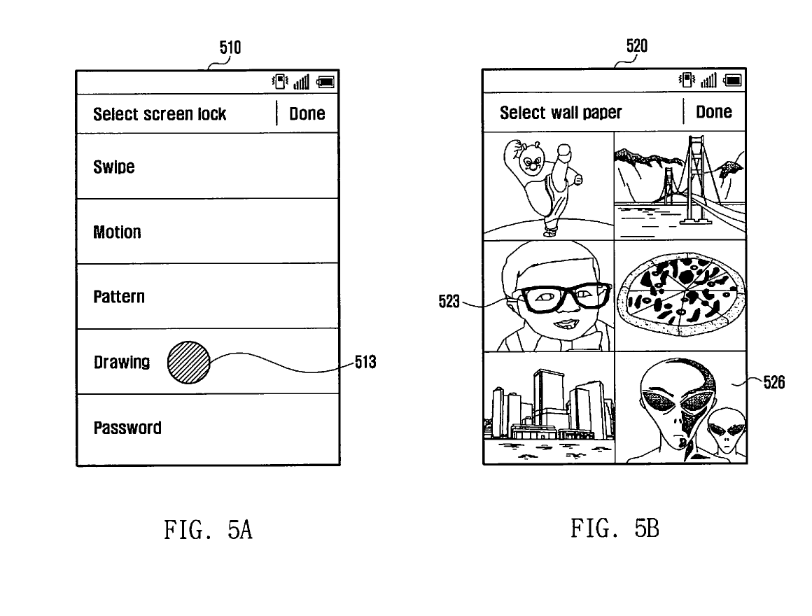

FIGS. 5A and 5B are screen views for illustrating an operation of selecting an image to be use as a lock image among lock screen settings according to an embodiment of the present invention.

Referring to FIGS. 5A and 5B, when the controller 100 is in a standby mode to detect a user input, if the input for setting the lock screen is detected through the touch panel 114, the controller 100 displays a lock screen setting list on the display unit 112 as illustrated on a screen 510 in FIG. 5A. As shown, the lock screen setting list may include items “Swipe”, “Motion”, “Pattern”, “Drawing”, “Password”. The item “Swipe” may be an item to release a lock screen in response to a swipe touch event generated from the touch panel 114. The item “Motion” may be an item that defines a specific motion collected based on at least one of various sensors such as an acceleration sensor, a geomagnetic sensor, an illumination sensor, a proximity sensor, and a gyro sensor as the lock release value. The item “Pattern” may be an item that defines a release of a lock screen when a pattern having a previously defined shape is input through a separately provided pattern input window. The item “Password” may be an item that defines a release of a lock screen through an input of a lock password.

Meanwhile, if the “Drawing” item 513 is selected from the lock screen setting list, the controller 100 may display a wall paper including at least one image on the display unit 112 as illustrated on a screen 520 in FIG. 5B. The controller 100 may read images stored in the storage unit 140 to display the read images in order to display a wall paper on the display unit 112. As described above, the images provided as the wall paper may include an image and a photograph provided as a background screen, an image collected by the photographing unit, and an image collected by another terminal.

In particular, the images output on the display unit 112 may be classified into the lock image and an unlocked image. The lock release value may be displayed on a corresponding image of the lock image. For example, if the image of a face wearing eyeglasses is the lock image as illustrated on screen 520 and the lock release value is an eyeglasses rim 523, the eyeglasses rim 523 may have an image effect for recognizing the lock release value. For example, the eyeglasses rim 523 may be highlighted. Meanwhile, the unlocked image may be displayed like an image 526 to which a separate highlight effect is not applied. In addition, a text indicating the state of lock setting or a specific display effect may be applied to a corresponding image of the lock image among specific images. Further, a currently applied lock image may display an image effect or a text indicating that the lock image is currently applied.

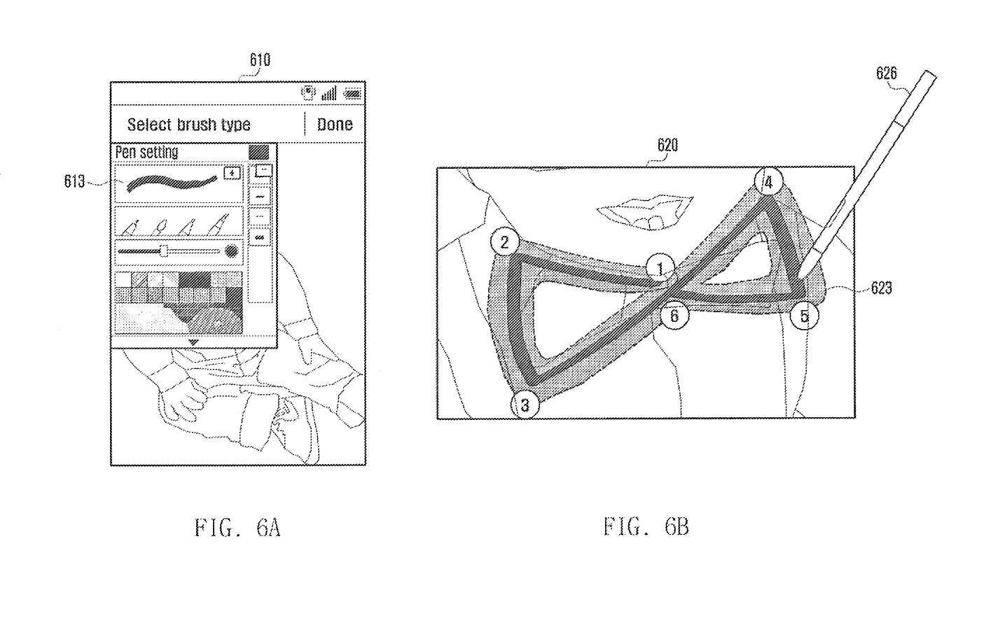

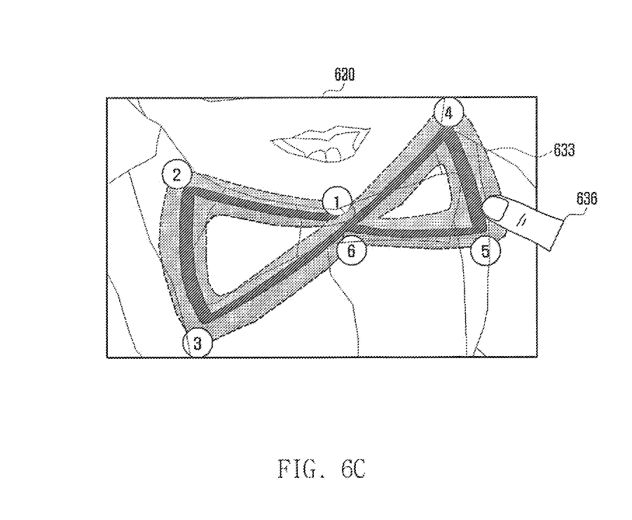

FIGS. 6A to 6C are screen views for illustrating a procedure of setting the lock screen according to an embodiment of the present invention.

Referring to FIG. 6A, the controller 100 controls the display unit 112 to display a Toolbar 613 for a brush type as illustrated on a screen 610. The Toolbar 613 may include an item to set a size or a shape of an input of a pen or a finger. Accordingly, the user may define a style of a pen input or a finger input having a specific type desired by the user by designating a specific item of the Toolbar 613. Such an input style value may be applied to a corresponding lock release value. A drawing element set as the lock release value, that is, a thickness or a style of a displayed line, may be applied to the lock release value.

Referring to FIG. 6B, the user performs an operation for a drawing input 623 on a screen 620 on which the lock image is displayed by using a finger or a pen 626. Here, the user may execute a zoom-in function of the lock image for the drawing input 623 of the lock image. To this end, the controller 100 controls to extend a certain region designated by the user and output on the display unit 112 when a drawing for lock release of the lock image is input. In FIG. 6B, the user may perform a zoom-in request for a location in which a ribbon is disposed. In response to this, the controller 100 extends and displays a corresponding region. In a case of a zoom-in function, when a previously defined specific input signal is generated for applying the zoom-in function while designating a specific region by the pen or the finger, the controller 100 controls to extend and display a corresponding region. Alternatively, the controller 100 may not support a separate zoom-in function. In this case, the lock image output on the display unit 112 may be maintained in a state in which the size of the image is not changed.

FIG. 6B illustrates a case where the lock release value includes an order value. The controller 100 collects the pen drawing input 623 including a start point (1) of a certain track, a certain track (2), (3), (4), (5), an intersection point, and an end point (6) according to the pen input of the user as illustrated on the screen 620 during a procedure of collecting the drawing input. Alternatively, when the lock release value is defined as a finger input, the controller 100 collects a finger drawing input 633 including a start point, a certain track, an intersection point, and an end point input by a finger 636 of the user as illustrated on a screen 630 of FIG. 6C.

The electronic device of the present invention may simply apply a drawing shape as the lock release value, and furthermore, as described above, may support a more improved security function by applying an order element for the lock release value.

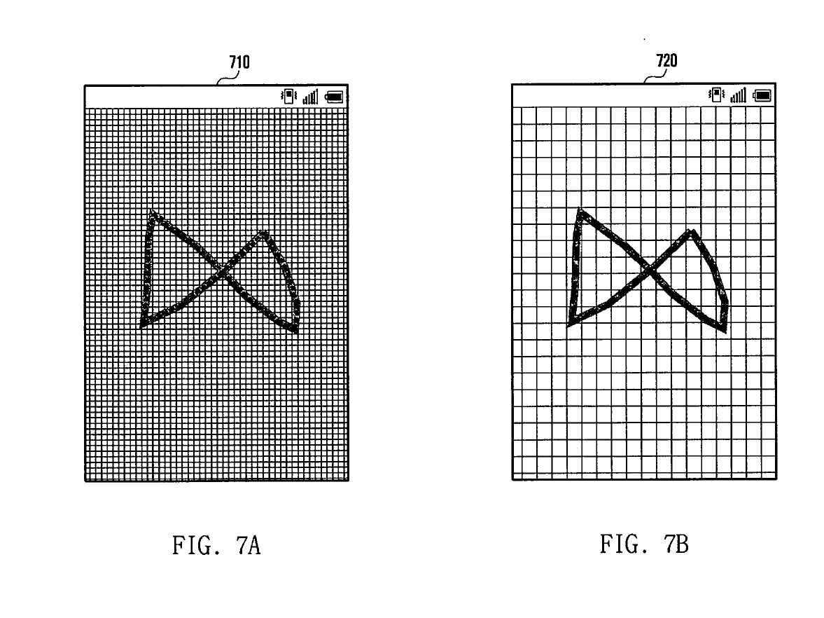

FIGS. 7A and 7B are screen views illustrating setting a degree of difficulty for a lock setting according to an embodiment of the present invention.

Referring to FIGS. 7A and 7B, the controller 100 supports a first lattice size as illustrated on a screen 710 in FIG. 7A in order to support a touch coordinate (x, y) for a lock release value. Further, the controller 100 may support a second lattice size wider than at least one first lattice size as illustrated on a screen 720 in FIG. 7B in order to support a touch coordinate for the lock release value. The second lattice size may have a touch coordinate (x, y) sparser than the first lattice size in order to support a touch coordinate (x, y) in a lattice. That is, if the lock release value is set in a state of a setting of the first lattice size, when a lock release function is performed based on a corresponding lock image, a more precise drawing input is required. On the contrary, if the lock release value is set in a state of a setting of the second lattice size, when the lock release function is performed based on the corresponding lock image, a drawing input having a relatively high error tolerance will be recognized.

Meanwhile, in the foregoing description, only the first lattice size and the second lattice size are illustrated, but the present invention is not limited thereto. That is, a third lattice size larger than the second lattice size may be applied to set the lock image, or a medium size of the first lattice size and the second lattice size may be applied to set the lock image. The user may set a lock release value in the lock image based on the first lattice size in order to set a higher degree of difficulty for lock. The controller 100 may provide a virtual button or a hardware button that can control lattice sizes in order to use various lattice sizes.

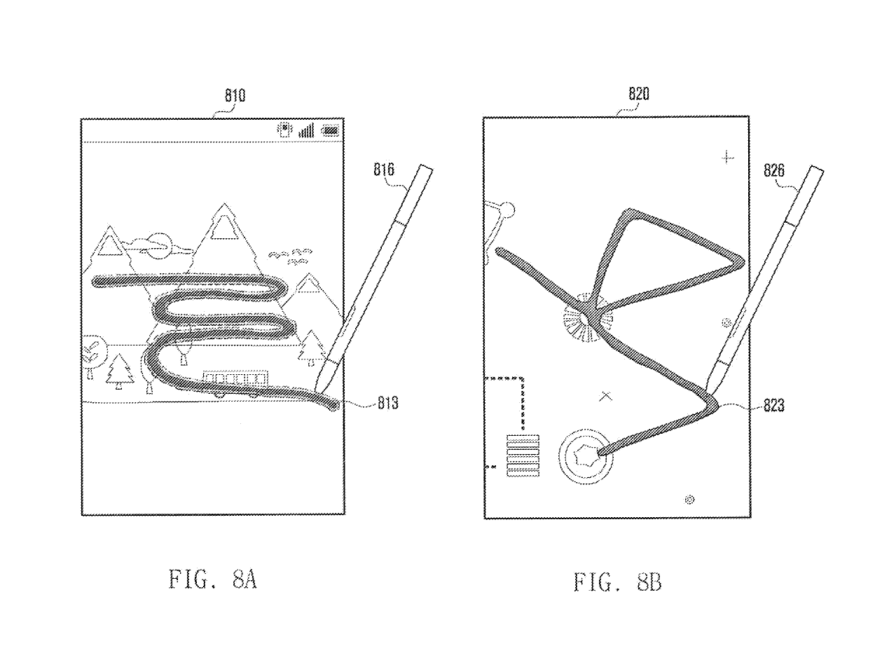

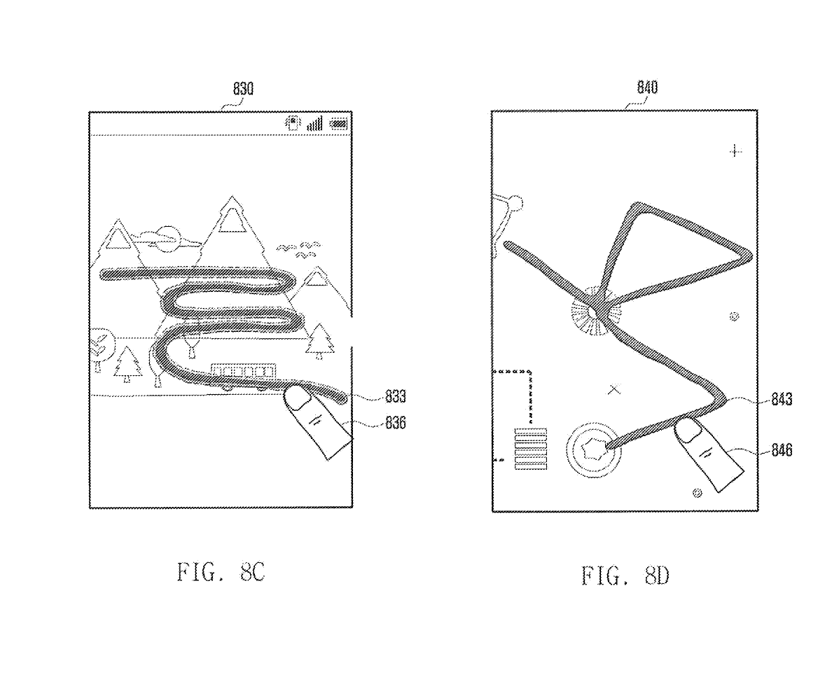

FIGS. 8A to 8D are screen views for illustrating a lock setting according to an embodiment of the present invention.

Referring to FIGS. 8A to 8D, the controller 100 displays the lock image on the display unit 112. In this case, the controller 100 detects drawing using an input means on the lock image to release the lock screen. For example, as shown in FIG. 8A, the user performs a pen drawing input 813 on the lock image by using a touch pen 816. If the pen drawing input 813 is generated, the controller 100 displays a corresponding image effect on the lock image. A lock release value in FIG. 8A may be an element of a previously defined line on the lock image. Accordingly, as shown in FIG. 8A, if the pen drawing input 813 corresponding to a line is generated, the controller 100 compares a corresponding pen drawing input 813 with the previously stored lock release value to determine whether to release the lock screen.

Meanwhile, FIG. 8B illustrates a lock release value on the lock image to which an element of a point is applied. For example, in FIG. 8B, a pen drawing input 823 including a specific image element which may be recognized as a plurality of points on the lock image based on a shown drawing is generated. Then, the controller 100 identifies the pen drawing input 823, and determines whether points included in a corresponding input are included in the previously defined lock release value. Further, when the points included in the pen drawing input 823 are identical with the points included in the lock release value, the controller 100 controls to release the lock screen. In this case, when the lock release value is set as a point, or a series of points, the line connecting the points with each other may be an element which is not applied to lock release. As a result, although the user draws various line patterns, if the pen drawing input is generated while including specific points on the previously defined lock image, the lock screen is released.

FIGS. 8C and 8D are diagrams illustrating a state in which the lock release value of FIGS. 8A and 8B is set by a finger. As described above, when the lock release value is set by the finger, although an exact lock release value is input as shown in FIGS. 8A and 8B, corresponding input values may not be recognized as a valid value. As a result, the controller 100 may recognize that only finger drawing input 833 and 843 by finger 836 and 846 as the valid value. Meanwhile, in the foregoing embodiment, it is described that the finger and the pen are distinguished. However, a drawing value input, regardless of whether the input is a finger input or a pen input, is compared with the lock release value. The controller 100 may separately provide a menu to set the lock release values distinguished according to the finger and the pen.

As described above, in order to support the lock function, the electronic device of the present invention may provide only the lock image as the lock screen, set at least one of constituent elements of an image, i.e., a point, a line and a plane included in the lock image as the lock release value, and execute the lock release based on the setting. Further, the electronic device of the present invention may differently define the lock release value according to whether the input is made by the finger or the pen, and may differently define an accuracy of the lock release value by adjusting the touch lattice size. As described above, the present invention may set and release various lock screens using only the lock image such that a more improved security function may be provided while satisfying the diverse needs of the user.

As described above, according to the method and the apparatus for operating the lock screen of the electronic device in accordance with the present invention, the present invention can reinforce a characteristic of the lock function while satisfying various needs of the user.

Further, the present invention can improve usability of the image which is used on the lock screen.

Although the method and the apparatus for releasing the lock screen in the electronic device with the lock screen according to embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims and their equivalents.

What is claimed is:

1. A method for operating a lock function in an electronic device, the method comprising:
displaying an image on a lock screen when the lock screen is called;
detecting a user input in a state in which the image is displayed; and
releasing the lock screen when the user input is identical with a lock release value,
wherein at least one of a point, a line, and a plane forming an image corresponding to the image is included in a drawing value for releasing the lock screen.

2. The method of claim 1, wherein releasing the lock screen comprises:
identifying an input device corresponding to a finger or a touch pen; and
processing the user input by a previously defined input device as a valid input.

3. The method of claim 1, further comprising:
receiving an input to extend at least part of the image; and
extending and displaying the at least part of the image according to the input.

4. The method of claim 1, further comprising displaying an image effect on the image in response to the detected drawing.

5. A method for operating a lock function, the method comprising:
displaying an image selected from one or more images;
receiving a user input including at least one of a point, a line, and a plane forming the displayed image; and
storing the user input as a lock release value of the image.

6. The method of claim 5, further comprising displaying a plurality of images to set a lock screen before displaying the selected image,
wherein displaying the plurality of images comprises distinguishing an image from an unlocked image.

7. The method of claim 6, wherein displaying the plurality of images comprises distinguishing an image applied to a current lock screen from other images.

8. The method of claim 5, further comprising:
activating a photographing unit to collect an image for setting a lock screen before displaying the selected image; and
providing the image collected by the photographing unit as the image.

9. The method of claim 5, wherein storing the user input comprises at least one of:
identifying and storing an order of the user input to store the user input; and
identifying and storing input device information used for the user input.

10. The method of claim 5, further comprising
controlling a lattice size of a touch coordinate to identify the user input before receiving the user input.

11. An electronic device for operating a lock function, the electronic device comprising:
a display unit configured to display an image on a lock screen when the lock screen is called;
a touch panel configured to detect a user input in a state in which the image is displayed; and
a controller configured to release the lock screen when the user input is identical with a lock release value,
wherein at least one of a point, a line, and a plane forming an image corresponding to the image is included in a drawing value for releasing the lock screen.

12. The electronic device of claim 11, wherein the controller identifies an input device corresponding to a finger or a touch pen, and processes the user input by a previously defined input device as a valid input.

13. The electronic device of claim 11, wherein, when receiving an input to extend at least part of the image, the controller is configured to control to extend and display the at least part of the image according to the input.

14. The electronic device of claim 11, wherein the display unit displays an image effect on the image in response to the detected user input.

15. An electronic device comprising:
a display unit configured to display an image selected from one or more images;
a touch panel configured to receive a user input including at least one of a point, a line, and a plane forming the displayed image;
a controller configured to control to store the user input as a lock release value of the image; and
a storage unit configured to store the lock release value and the selected image.

16. The electronic device of claim 15, wherein the display unit displays a plurality of images to set a lock screen before displaying the selected image while distinguishing an image from an unlocked image.

17. The electronic device of claim 16, wherein the display unit distinguishes an image applied to a current lock screen from other images.

18. The electronic device of claim 15, further comprising a photographing unit configured to collect an image for setting a lock screen,
wherein the controller is configured to provide the image collected by the photographing unit as the image.

19. The electronic device of claim 15, wherein the controller is configured to control to identify and store at least one of an order of the user input and input device information used for the drawing input.

20. The electronic device of claim 15, wherein the controller is configured to control a lattice size of a touch coordinate to identify the user input according to an input event.
